(19) United States
(12) Patent Application Publication
(10) Pub. No.: US 2017/0344675 A1
(43) Pub. Date: Nov. 30, 2017

(54) Method for Operating an Automation Device and Automation Device

(71) Applicant: Siemens Aktiengesellschaft, Muenchen (DE)

(72) Inventors: Benjamin Lutz, Pfinztal (DE); Wolf Gerrit, Karlsruhe (DE)

(73) Assignee: SIEMENS AKTIENGESELLSCHAFT

(21) Appl. No.: 15/607,252

(22) Filed: May 26, 2017

(30) Foreign Application Priority Data
May 31, 2016 (EP) 16172128.7

(51) Int. Cl. G06F 17/50; G06F 9/455; G05B 17/02

(52) U.S. Cl. CPC G06F 17/5009; G05B 17/02; G06F 9/45533

(57) ABSTRACT

A method for operating an automation device including at least one real automation unit for controlling a technical process, an operator station for operating and observing the technical process to be controlled, an engineering system and virtual automation units which each simulate functions of a real automation unit and is stored on a server, wherein suitable measures are used to particularly simplify the start-up of the automation device, where a suitable distribution of the virtual controllers or automation units on servers to a large extent guarantees real-time behavior of the automation device.

### BACKGROUND OF THE INVENTION

### 1. Field of the Invention

The invention relates to an automation device and method for operating an automation device comprising at least one real automation unit for controlling a technical process, an operator station for operating and observing the technical process to be controlled, an engineering system and virtual automation units each of which simulates functions of a real automation unit and is stored on a server.

### 2. Description of the Related Art

In automation technology, ever increasing use is being made of simulations provided for testing control programs for automation units (programmable logic controllers, (PLCs)), for virtual start-up or for the migration of automation components. To this end, both the automation components and processes are typically modeled and operated virtually on computers or servers.

However, to enable conclusions also to be drawn for real automation components from a simulation of this kind, it is necessary to observe certain boundary conditions that have to be satisfied by a simulation of this kind. For example, within the context of automation technology, it is important that behavior with respect to the real-time and deterministic function of the results is in conformity with the real automation components of the automation device. If all automation components (e.g., controllers, decentralized peripherals, I/O modules, actuators, sensors, communication modules and processes) are formed virtually, it is automatically possible to decouple the real-time behavior in some way and to “rein in” the simulation of the virtual automation components in order to guarantee the deterministic function. Within the framework of mixed configurations, i.e., in automation devices comprising both real and virtual automation components or simulation automation units, real-time violations are not permissible because the real automation components are immediately disrupted as a result of an identified cycle-time violation or real-time violation and issue an error report. This faulty real-time behavior of the virtual components makes it impossible to have a trouble-free start-up of the automation device in which successive virtual automation units are started up before being replaced by real automation units following the achievement of a satisfactory simulation.

### SUMMARY OF THE INVENTION

In view of the foregoing, it is therefore an object of the invention to provide an automation device and method that particularly simplifies the start-up of the automation device.

This and other objects and advantages are achieved in accordance with the invention by an automation device and method in which a suitable distribution of virtual controllers or virtual automation units (simulation automation units) on servers to a large extent advantageously enables real-time behavior of the automation device, where cost-optimal “simulation distribution” is additionally guaranteed. It is only necessary for the hardware (e.g., server, computer) required for this “simulation distribution” to be provided. Moreover, the real-time behavior or the real-time capability of the automation device to a large extent guarantees that the later use of real automation units instead of the virtual automation units will enable production to be started without any problems.

The invention is based on the concept of determining the utilization (computing load) or loading of the server in that the utilization or loading of the virtual automation units (simulation automation unit) is detected. In the event that the utilization or loading has reached or exceeded a threshold value, the virtual automation unit or units is/are transferred to a further server or to a plurality of further servers. In this context, the threshold value is selected to ensure that real-time behavior of the automation device is guaranteed. Each automation unit and each virtual automation unit comprises system functions, where an engineering system and one of these system functions (hereinafter monitoring and control system function) are used to configure, and optionally parameterize, process objects and this monitoring and control system function is further used to monitor the other system functions with respect to utilization of the respective automation unit and the respective virtual automation unit.

A first configured number of the process objects represents the loading (computing load) of the respective automation unit and the respective virtual automation unit with respect to the process control, a second configured number of the process objects represents the loading of these units with respect to the communication between the automation units and the operator station and a third configured number of the process objects represents the loading with respect to the communication between the real and virtual automation units.

A further one of these system functions (hereinafter the first system function (processing)) creates a computing load on the units by processing the first configured number of the process objects, which are provided to control the technical process on the respective automation units and virtual automation unit. These process objects are, for example, processed with typical advanced process library (APL) computing operations.

A further one of these system functions (hereinafter the second system function (communication between automation unit and operator station; AS-OS communication)) is used to create a computing load on the respective automation units and respective virtual automation units by processing the second configured number of the process objects relevant for the operation and observation of the respective unit by the operator station. Hence, the processing of these process objects is important for the creation of the communication load between the respective unit and the operator station.

A further system function (hereinafter the third system function (communication between the automation units) processes the third configured number of the process objects. This processing creates a computing load on the respective units which, is caused as a result of the communication or data exchange between the units (between the real automation units, the real and virtual automation units and between real and virtual automation units). Hence, this system function enables a defined number of process objects to be loaded from a defined unit and vice versa also to be transferred to this unit (in the cycle in which the process object is also processed). For example, this enables the implementation of a CFC plan interconnection between the units across multiple controllers or across multiple units during the operation of the automation device.

Due to the fact that the units (automation units and virtual automation units) are provided to resolve different (part) automation problems, the configured process objects stored in the automation units and virtual automation units are different. For example, sensors and actuators are connected to a real automation unit for monitoring the temperature of a heating boiler, and a further automation unit or a virtual automation unit uses further suitable real or virtual automation components to monitor the speed of a motor.

As explained, an engineering system and the monitoring and control system function are used to configure, and optionally parameterize, the process objects and this monitoring and control system function further monitors the other system functions with respect to utilization of the respective automation unit and respective simulation automation unit. In this context, an operator is able to parameterize and change the process objects of the first, second and third system function online during the operation of the automation device by making suitable entries at the operator station. For example, it is possible to set or change the first, second and third number of process objects on the respective real and virtual automation unit. Moreover, the parameters of the process objects can be sent to the operator station and visualized thereon, where this display can be used to identify and evaluate the respective utilization of the real and virtual automation units. For example, the transmitting and/or receiving buffers of the automation units for the communication between the automation units and the operator station (AS-OS communication) and/or the actual reserve time of a cyclic operation module (cycle-time monitoring) or other relevant events of a further operation module (event-monitoring module) can be displayed on the operator station. Outputs or displays of this kind are used to identify a possible cause of excessively high utilization resulting in a real-time violation (sending and/or receiving buffer full), thus providing evidence that one or more virtual automation units have to be distributed on another server to relieve the load. For example, the virtual automation unit that is the earliest to have a real-time violation can be transferred to another server and executed there.

In one embodiment of the invention, in the event of the monitoring and control system function on the at least one real automation unit identifying that utilization has reached or exceeded a threshold value, a plurality of process objects of the real automation unit are transferred to a further real automation unit for processing. This relieves the load on the at least one real automation unit and guarantees real-time behavior.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and the embodiments and advantages thereof are described with reference to the drawing illustrating an exemplary embodiment of the invention, in which:

FIGS. 1 to 3 show automation devices in accordance with the invention; and

FIG. 4 is a flowchart of the method in accordance with the invention.

### DETAILED DESCRIPTION OF THE EXEMPLARY EMBODIMENTS

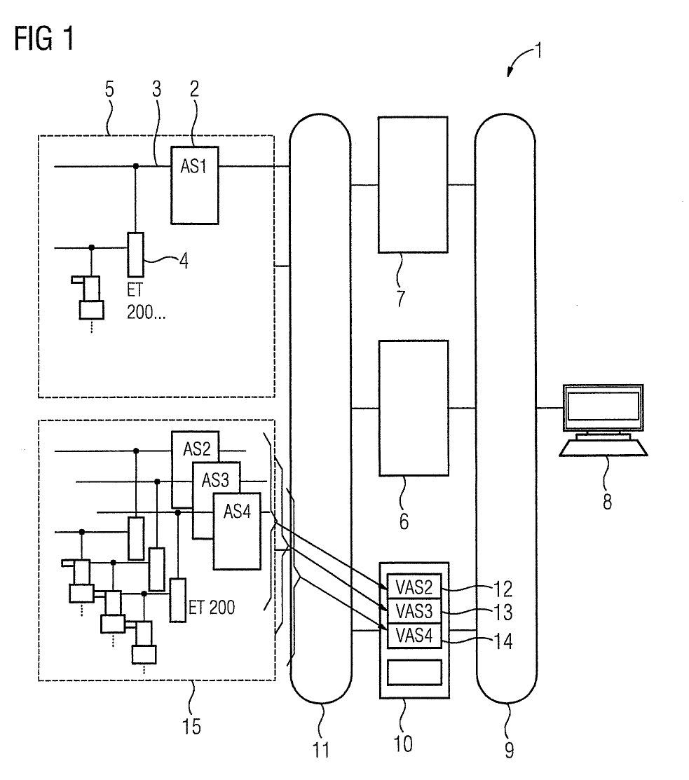

Identical parts depicted in FIGS. 1 to 3 are given the same reference characters.

In FIG. 1, reference numeral 1 designates an automation device comprising a real automation unit 2 connected by a field bus 3 to a decentralized peripheral unit 4. This decentralized peripheral unit 4 is provided with an interface assembly and with a plurality of process-input and process-output assemblies, where sensors are connected to the respective process-input assemblies and actuators are connected to the respective process-output assemblies. For purposes of simplicity, the present example only depicts a real configuration 5 of real automation components (automation unit 2, decentralized peripheral unit 4, etc.). An automation device of this kind typically comprises a plurality of such automation components to control a technical process or to solve an automation problem. The automation device 1 further comprises an engineering system 6 for planning, configuring and parameterization of the automation device 1 and an operator station 7, which enables an operator to monitor and control the process in a comfortable and safe way. If required, the operator can intervene in the course of the process for control purposes, which means that the operator can control and observe the technical process to be controlled by the automation device 1. The operator can use a client 8, which is typically a component of the operator station 7 and/or the engineering system 6, to access the planning software of the engineering system 6 and/or the control and observation software of the operator station 7 via a terminal bus 9 for reading or writing purposes. Therefore, in the present example, the client 8 represents both an operator station (OS) client and an engineering system (ES) client. The engineering system 6, the operator station 7, a server 10 and the automation unit 2 are connected to a further bus, i.e., a system bus 11. The server 10 represents a simulation server upon which virtual automation units 12, 13, 14 are stored. These virtual automation units 12, 13, 14 represent real automation units and are implemented in the form of software. In other words, the functioning principle and mode of operation of real automation units are simulated via the virtual automation units 12, 13, 14, where the server additionally simulates virtual decentralized peripherals and sensors and actuators, which are in operative connection with the simulation automation units 12, 13, 14, which is shown as a virtual configuration 15 in the drawing. Due to the fact that the automation device 1 is provided with both real and virtual automation components, this automation device 1 represents a mixed configuration which, within the context of a start-up or within the context of a system extension or an extension of the automation device, has to satisfy real-time requirements.

In order to satisfy these requirements, in particular within the context of a start-up of the automation device, each of the real and virtual automation units 2, 12, 13, 14 comprises a plurality of system functions. A system function, called a monitoring and control system function, and the engineering system 6 can be used to configure and parameterize process objects, where in addition, during the control operation, this monitoring and control system function monitors the other system functions with respect to utilization of the respective automation unit and the respective virtual automation unit. During an engineering phase, the process objects are determined in accordance with the automation problem to be solved and simulated automation problem to be solved, where the automation problem to be solved is usually pre-specified with references to plans, or invitations to tender.

A first number of these process objects are configured for the process control, where these process objects are stored on the real automation unit 2 and the virtual automation units 12, 13, 14. Each of these automation units 2, 12, 13, 14 solves a part of the automation problem or simulated automation problem as a result of which the configured process objects stored on the different automation units 2, 12, 13, 14 are different. A second number of the process objects are configured for communication between the respective automation unit 2, 12, 13, 14 and the operator station 7, 8 and a third number of the process objects are configured for communication between the automation units 2, 12, 13, 14.

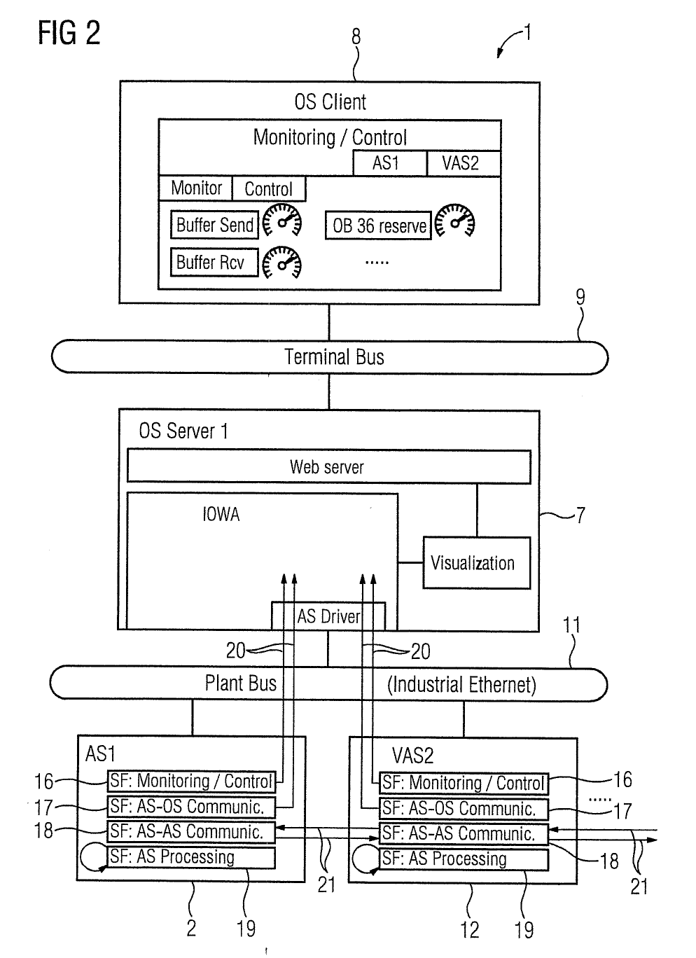

FIG. 2 shows system functions 16, 17, 18, 19 for the real automation unit 2 and for the virtual automation unit 12 of the automation device 1, where the system function 16 is formed as a monitoring and control system function and wherein it is assumed that the virtual automation units 12, 13, 14 are setup and stored on the server 10. In FIG. 2, arrows 20 indicate the communication between the respective automation units 2, 12 and the OS-station 7, 9 and arrows 21 the communication between the automation units 2, 12, etc.

The system function 17 (communication between automation unit and operator station; AS-OS communication) generates a computing load on the respective automation units 2, 12, 13, 14 by processing the (AS-OS communication) process objects relevant for the operation and observation of the respective unit 2, 12, 13, 14 by the operator station.

The system function 18 (communication between the automation units 2, 12, 13, 14; AS-AS communication) processes AS-AS communication process objects on the respective unit. As a result, a computing load caused by the communication or data exchange between the units is generated on the respective unit 2, 12, 13, 14.

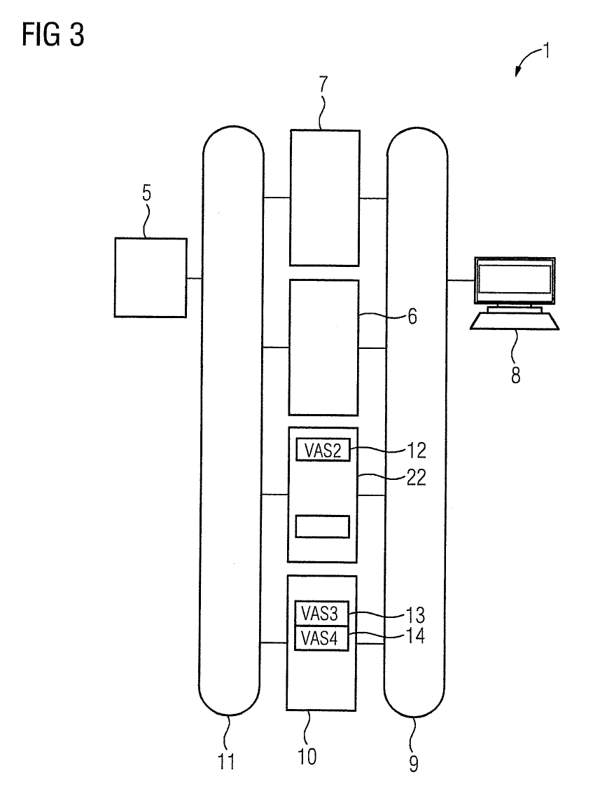

With the system functions 19 (processing), the processing of the process objects provided to control the technical (sub)process on the respective automation unit 2, 12, 13, 14 causes the generation of a computing load on the unit. The OS clients 8 also display the utilization or loading of the system functions 17, 18, 19, which are monitored by the system function 16 (monitoring and control). In the present exemplary embodiment, the utilization of the respective system functions 17 (AS-OS communication) of the real automation unit 2 and the virtual automation unit 12 are displayed on the OS client 8. It should be understood the loading of the further system functions 18, 19 can also be displayed on the OS client 8. In the event of the system function 16 of the virtual automation unit 12 identifying that the utilization or loading of the system function 17 has reached or exceeded a threshold value as a result of which the pre-specified processing cycle of automation device 1 is exceeded or the real-time behavior of the automation device 1 is no longer guaranteed, the virtual automation unit 12 is then transferred to a further server 22 (FIG. 3). It should be understood the virtual automation unit 12 is also transferred to the further server 22 if the system function 16 identifies that the utilization or loading of the system function 18 or 19 has reached or exceeded a threshold value because, once again, with overloading of this kind, real-time behavior of the automation device 1 is no longer guaranteed.

The transfer of a virtual automation unit 12, 13, 14 can occur via the system function 16 of the overloaded, virtual automation unit 12, 13, 14. The system function 16 automatically transfers the overloaded automation unit 12, where, to this end, this system function 16 and the server 22 are provided with suitable “transfer” software. It should be understood the transfer can also be performed by the engineering system 6, where the system function 16 displays to the engineering system 6 any overloading on the basis of which the engineering system 6 implements the transfer to the server 22.

The measures described enable the “calibration” of the virtual automation units, where the following procedure is preferred:

the virtual automation units are initially “placed” on a server,

the execution of the respective monitoring and control system function causes the execution of respective other system functions on the respective virtual automation unit to be monitored,

in the case of a cycle-time violation or an insufficient cycle-time reserve of one of the virtual automation units, this unit is transferred to a further server,

d) steps b) and c) are repeated until the real-time capability of the automation device is achieved.

If the real-time capability of the automation device has been achieved, the virtual automation units can be replaced by real automation units.

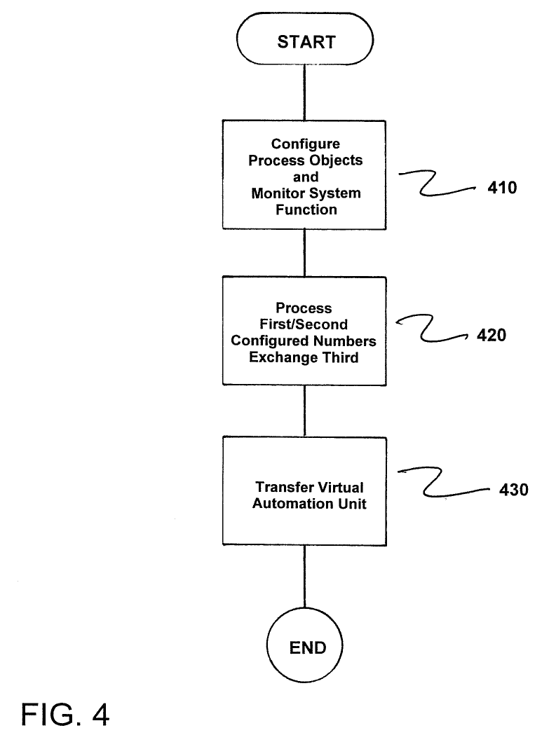

FIG. 4 is a flowchart of a method for operating an automation device 1 comprising at least one real automation unit 2 for controlling a technical process, an operator station 7 for operating and observing the technical process to be controlled, an engineering system 6 and virtual automation units 12, 13, 14 that each simulate functions of a real automation unit and is stored on a server 10, where the automation unit 2 and the virtual automation units 12, 13, 14 each comprise system functions 16, 17, 18, 19.

The method comprises configuring process objects for other system functions 17, 18, 19 via the engineering system 6 and a system function of the system functions 16 and monitoring a system function 16 of the other system functions 17, 18, 19 with respect to utilization of a respective automation unit 2, 12, 13, 14 via the engineering system 6 and a system function of the system functions 16, as indicated in step 410.

Next, a first configured number of the process objects on the respective automation unit 2, 12, 13, 14 is processed via the other system functions 17, 18, 19, a second configured number of the process objects is exchanged between the respective automation unit 2, 12, 13, 14 and the operator station 7, 8 via the other system functions 17, 18, 19, and a third configured number of the process objects is exchanged between the respective automation unit 2, 12, 13, 14 and the further automation units 2, 12, 13, 14 via the other system functions 17, 18, 19, as indicated in step 420.

Next, a virtual automation unit is transferred to a further server 22 in the event of the system function 16 on a virtual automation unit of the virtual automation units 12, 13, 14 identifying that the utilization of the respective other system functions 17, 18, 19 has reached or exceeded a threshold value, as indicated in step 430.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an automation device comprising at least one real automation unit for controlling a technical process, an operator station for operating and observing the technical process to be controlled, an engineering system and virtual automation units which each simulate functions of a real automation unit and is stored on a server, wherein the at least one real automation unit and the virtual automation units each comprise system functions, the method comprising:
configuring process objects for other system functions via the engineering system and a system function of the system functions and monitoring a system function of other system functions with respect to utilization of a respective automation unit via the engineering system and the system function of the system functions;
processing a first configured number of the process objects on the respective automation unit via the other system functions, exchanging a second configured number of the process objects between the respective automation unit and the operator station via the other system functions, and exchanging a third configured number of the process objects between the respective automation unit and the further automation units via the other system functions; and
transferring a virtual automation unit to a further server in an event of the system function on the virtual automation unit of the virtual automation units identifying that the utilization of the respective other system function has reached or exceeded a threshold value, this.

2. The method as claimed in claim 1, further comprising:
transferring a plurality of process objects of the at least one real automation unit is transferred to a further real automation unit for processing in the event of the one system function of the one system function on the at least one real automation unit identifying the utilization has reached or exceeded a threshold value.

3. An automation device comprising:
at least one real automation unit for controlling a technical process;
an operator station for operating and observing the technical process to be controlled;
an engineering system; and
virtual automation units which each simulate functions of a real automation unit and is stored on a server;
wherein the at least one real automation unit and the virtual automation units each comprise system functions;
wherein the engineering system and a system function of the system functions are configured to process objects and the system function is further configured to monitor other system functions with respect to utilization of a respective automation unit;
wherein the other system functions are configured to process a first configured number of the process objects on the respective automation unit, exchange a second configured number of process objects between the respective automation unit and the operator station, exchange a third configured number of the process objects between the respective automation unit and further automation units; and
wherein the automation device is configured to transfer a virtual automation unit of the virtual automation units to a further server in an event that utilization of the respective other system functions has reached or exceeded a threshold value is identified via the system function on the virtual automation unit of the virtual automation units.

4. The automation device as claimed in claim 3, wherein the automation device is further configured to transfer a plurality of process objects of the at least one real automation unit to a further real automation unit for processing in the event that the utilization has reached or exceeded the threshold value is identified via the one system function on the at least one real automation unit.

5. A virtual automation unit configured for an automation device as claimed in claim 3.

6. A virtual automation unit configured for the automation device as claimed in claim 4.

7. An automation unit configured for the automation device as claimed in claim 3.

8. An automation unit configured for the automation device as claimed in claim 4.
